(19) United States
(12) Patent Application Publication
(10) Pub. No.: US 2013/0088004 A1
(43) Pub. Date: Apr. 11, 2013

(54) Securing Band and Methods of Using Same

(71) Applicant: Michelle Ann Young, Olathe, KS (US)

(72) Inventor: Michelle Ann Young, Olathe, KS (US)

(73) Assignee: Scrapbands LLC, Olathe, KS (US)

(21) Appl. No.: 13/437,623

(22) Filed: Apr. 2, 2012

Related U.S. Application Data
(60) Provisional application No. 61/470,799, filed on Apr. 1, 2011.

(51) Int. Cl. B42D 12/00

(52) U.S. Cl. CPC B42D 12/00
USPC 281/15.1

(57) ABSTRACT

The present disclosure, in one embodiment, relates to a scrapbook band that includes an elastic material sized for wrapping around a scrapbook album. The scrapbook band also includes at least one landing area being provided on the elastic material.

### CROSS REFERENCE TO RELATED APPLICATION

The application claims priority to U.S. Provisional Application No. 61/470,799, filed on Apr. 1, 2011, which is hereby incorporated herein in its entirety.

### FIELD OF THE INVENTION

The present disclosure relates to novel and advantageous securing bands. More particularly, the present disclosure relates to securing bands for securing books, notebooks, boxes, folders, loose-leaf materials, newspapers, etc. In a more particular embodiments, the present disclosure relates to a securing band for a scrapbook that may be placed around a scrapbook album for holding page protectors in place on the rings of a 3-ring album, holding the covers of an album towards one another, retaining the scrapbook pages in the page protector, and/or providing a label for the album.

### BACKGROUND OF THE INVENTION

Scrapbooking is a multi-billion dollar industry. People who scrapbook (“Scrapbookers”) spend a lot of time and in many cases money creating their own personalized scrapbooks. Often times the scrapbooks document significant events in the Scrapbookers' lives, and accordingly, the scrapbooks have great value to their owners.

Scrapbooking generally entails gathering, cropping, arranging and displaying a collection of photos and mementos on pages. The pages may be decorated using colored/designed paper, cardstock, stickers, die-cuts, stamps, 3-D embellishments, ribbons, buttons and more. The finished pages are most typically slipped inside plastic slipcovers (page protectors) to be bound inside post-bound albums or 3-ring albums. The finished product is called a scrapbook.

Scrapbook pages (and books) often involve specific themes. For example, a baby scrapbook may chronicle the journey from pregnancy to a baby's first birthday. Thousands of themes, styles and designs may be used in scrapbooking. Examples of some of the most common themes include: baby books, family trees, friendship, weddings, travel, school pictures, birthdays, sports and pets. Scrapbook elements are commonly designed according to these themes.

To assist consumers in making books based on their desired theme, manufacturers have developed complete scrapbooking kits. Kits include a complete package of accessories or elements in one specific design. The elements may be purchased in a prepackaged kit or individually and may be mixed and matched. Accordingly, even if consumers do not purchase a complete kit, they can usually find a match for almost every accessory among the wide-ranging selection of designs.

Every scrapbook album is unique, creative and personal to an individual's taste. Consumers generally want the ability to select their scrapbooking accessories to closely match their album's colors and themes.

Finished scrapbook pages are most typically slipped into page protectors and these page protectors put into a post-bound album or 3-ring album. While 3-ring albums are increasingly popular for usage as scrapbook albums, a number of issues arise for their usage as such.

A first issue relates to the integrity of the page protectors placed in the album. The page protectors commonly are manufactured from a relatively low-grade plastic. Some reinforcement may be provided along the through-ways for receiving the rings of the album but oftentimes no reinforcement is provided. The weight of the finished scrapbook page can be many times that of the page protector. Because scrapbooks are intended for displaying memories, they are frequently moved about and taken to places where they may be displayed and enjoyed. When moved, especially if the open end of the 3-ring album is generally positioned downwardly, the weight of the pages can create tension on the page protector such that the page protector rips at one or more of the holes in the page protector that receives the rings.

A second issue relates to capacity of the album for receiving page protectors. A 3-ring album has a fixed ring size for receiving page protectors but typically has flexibility on the edges of its covers such that the covers may generally angle towards one another when the album is not filled to capacity and may generally angle away from one another when the album is filled past capacity. With some themes, it is not ideal to split the scrapbook into two albums—for example a wedding scrapbook, a baby scrapbook, a vacation scrapbook, etc. There thus is a tendency towards overfilling albums to complete the theme. The overfilling of the album can compromise integrity of the page protectors. Further, an overfilled scrapbook may be generally unattractive, which detracts from the purpose of creating one in the first place.

A third issue relates to retention of the scrapbook pages in the page protector. Individual scrapbook pages may slip out of the page protectors when the album is moved, particularly if the scrapbook is held, moved, and/or stored upside down.

A fourth issue relates to labeling of finished scrapbooks. Many scrapbook albums' do not have a label or a place for a label on the outside spine of the album. Consumers wishing to display their scrapbooks in a bookshelf, for example, frequently desire a label indicating the content of the album. Therefore there is a need for a device that helps secure the pages of a scrapbook securely and attractively.

### BRIEF SUMMARY OF THE INVENTION

The present disclosure, in one embodiment, relates to a scrapbook band that includes an elastic material sized for wrapping around a scrapbook album. The scrapbook band also includes at least one landing area being provided on the elastic material. The scrapbook band can be a closed loop that has a landing area that is a sleeve that is made of fabric in some embodiments, while in other embodiments the sleeve may be made of cardstock. The scrapbook may also include one or more embellishments. The scrapbook band can have an open length design that in some embodiments may have a plurality of closures. In some embodiments the open length design scrapbook band can have one or more landing areas that comprise a sleeve. The sleeve can be comprised of fabric in one embodiment, while in another embodiment it can comprise cardstock. The scrapbook band can include one or more embellishments.

Another embodiment of the present disclosure comprises a scrapbook assembly that includes a 3-ring notebook with a plurality of 3-hole punched protective sheets. It also includes one or more pages that may be disposed inside of the protective sheets. The assembly also includes a securing strap that is removably securable to the exterior of the notebook, the securing strap having one or more landing areas. In some embodiments, the securing strap includes at least one embellishment.

In another embodiment, the present disclosure is directed to a method of securing a scrapbook. The method includes providing a scrapbook, the scrapbook having one more pages; and wrapping a scrapbook band around an exterior of the scrapbook, the scrapbook band being elastomeric and having at least one landing area.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 illustrates a basic closed loop scrapbook band, in accordance with one embodiment.

FIG. 2 illustrates a basic open length scrapbook band, in accordance with one embodiment.

FIGS. 3A and 3B illustrate predecorated closed loops scrapbook bands, in accordance with various embodiments.

FIG. 4 illustrates a predecorated closed loop scrapbook band around a scrapbook album in accordance with one embodiment.

FIG. 5 illustrates a customizable scrapbook band with example landing areas in accordance with one embodiment.

FIG. 6 illustrates a scrapbook band having a landing area in accordance with some embodiments.

FIG. 7A illustrates an open, unbanded scrapbook album in accordance with some embodiments of the present disclosure.

FIG. 7B illustrates the scrapbook album of FIG. 7A closed using a scrapbook band in accordance with one embodiment.

### DETAILED DESCRIPTION

The present disclosure relates to novel and advantageous devices and methods for securing a book or group of items. More particularly, a band that may be decorated or embellished is provided for securing around a book, newspapers, magazines, letters, journals, loose-leaf items, etc. Even more particularly, a scrapbook band is provided for use with scrapbook albums. While the embodiments described below will be described with regard to use with a scrapbook, it will be understood that the band may have other uses and applications with other items, and accordingly is not limited to use with a scrapbook.

Generally, a scrapbook consists of uniquely decorated individual pages that may contain photographs, graphics, decorative items, embellishments, fabric, or anything else a user may wish to affix to a page. The pages are generally created individually while not in the scrapbook. After the page is completed, the page may be placed in a page protector that is usually made of clear, relatively thin plastic, such that the page may be protected but also visible. The scrapbook is a collection of individual pages that may be housed in individual page protectors. The page protectors may have one or more (commonly three) holes punched in and along one or more edges of the page protector so that they may be placed in a binder, e.g. a 3-ring binder. It will be understood, however, that embodiments of the present disclosure are not limited to use with 3-ring binders, but may be used with binders, books, folders, etc. of any configuration. Other scrapbook types are also known. For example, a scrapbook may come pre-bound with a fixed number of pages that may generally not be removable. In such cases, a scrapbooker may decorate pages while the pages are in the book. Other types of scrapbooks are also known. The binder or band of the present disclosure may advantageously be used with any type of scrapbook. The band of the present disclosure may wrap around the outside of a scrapbook album, thereby holding the page protectors in place on the rings of an album, holding the covers of an album towards one another, retaining the scrapbook pages in the page protector, and/or providing a possible label for the album.

In some embodiments, the scrapbook band may comprise a strip of elastic material having an elasticity suitable for holding a scrapbook album closed as it ranges from underfilled to overfilled. The scrapbook band acts to keep the scrapbook album and its contents secure. The product prevents album covers, page protectors, scrapbook pages and other contents from slipping and thus compromising the integrity of the album and its contents.

In addition to the function of protecting the integrity of the scrapbook album, the scrapbook band may be used to wrap a scrapbook for gift giving; a way to add further embellishment or decoration to the scrapbook; and a way to label the scrapbook. The scrapbook band thus is simple, functional, and facilitates creative expression—an important factor in scrapbook accessories.

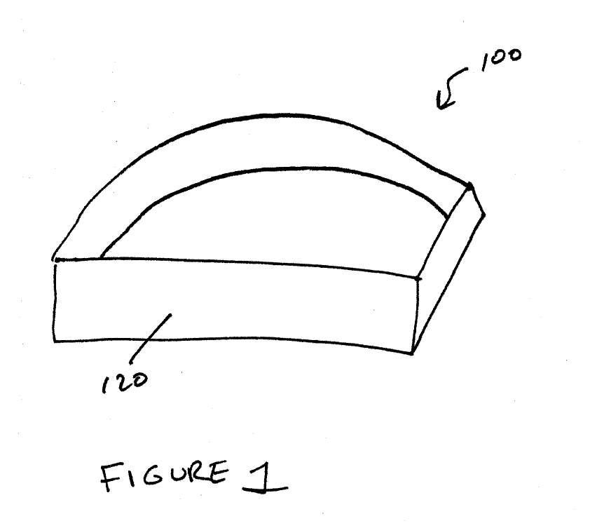

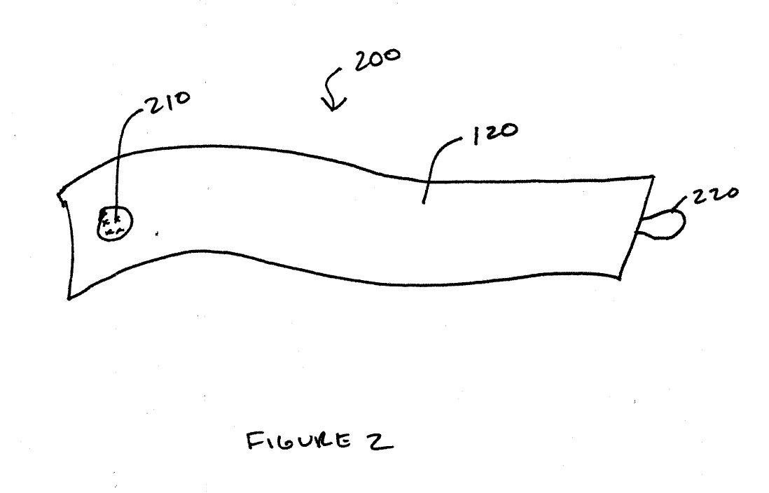

The scrapbook band generally comprises a band sized for provision around the outside of a scrapbook album. The band may be a preformed closed loop or may be a length that is closable around the album. FIG. 1 illustrates a basic closed loop 100 embodiment. FIG. 2 illustrates a basic open length 200 embodiment. It is to be appreciated that any suitable closure mechanism may be provided at the ends of the open length. In the embodiment shown in FIG. 2, a button 210 and loop 220 are provided.

The band 120 may be made from a durable elastic material, in some embodiments. Any suitable elastic material may be used to construct the band 120, such as elastic, rubber, plastic, or any other suitable material or combination of materials. In closed loop 100 designs, the elastic material may be sewn end to end. A reinforced stitch may be used to provide increased strength and integrity for holding burgeoning scrapbook albums closed. The degree of elasticity of the band may be selected for intended use. In some embodiments, a highly elastic band may be used such that the band may tightly close albums ranging from very empty to very full. In other embodiments, a less elastic band may be used to facilitate further customizability—via stamping, painting, etc. A band with high elasticity may mar the stamping or painting when stretched. By limiting the elasticity, and focusing the size to a standard album size as filled, the band may be further customized. To increase size options for a less elastic band, a plurality of closure positions may be provided—such as with a hook and eye closure having a plurality of provided eyes—thereby facilitating usage from an empty album to a burgeoning album. In other embodiments, the band may be comprised of a material that is generally not elastic or relatively less elastic, for example, leather, plastic, felt, fabric, rope, etc. In such embodiments, closures may be used to secure the band around an object.

Every scrapbook album is unique, creative and personal to an individual's taste. Consumers generally want the ability to select their scrapbooking accessories to closely match their album's colors and themes. Decorations, known as embellishments, provide eye-catching features. The scrapbook bands may be provided pre-made with designs and embellishments, or they may be provided plain and ready to decorate, thus allowing consumers to add their own band-appropriate embellishments.

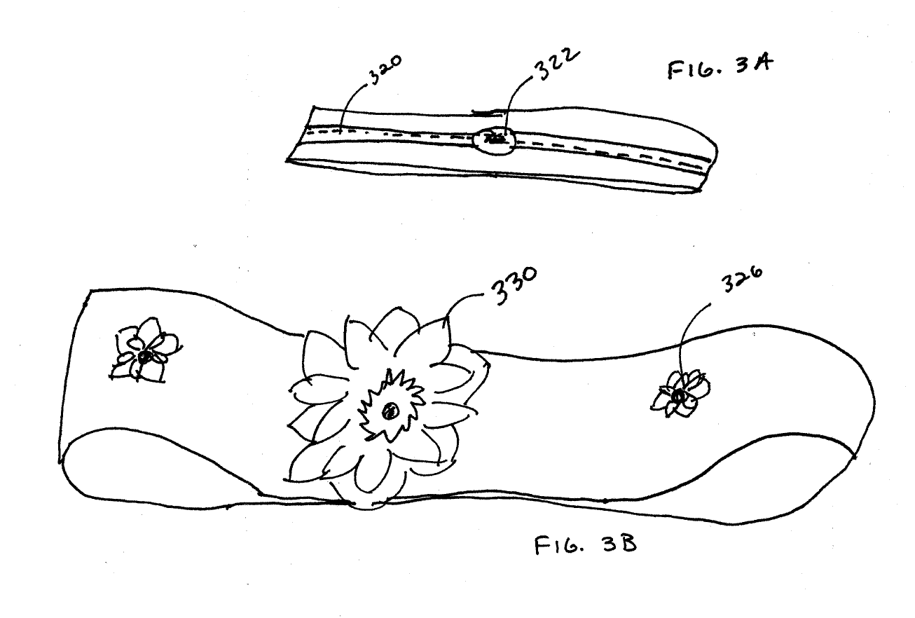

Accordingly, the band may be predecorated with ready-to-use styles and designs and/or may be suitable for receiving embellishments. FIGS. 3A and 3B illustrate embodiments of closed loop design predecorated with various embellishments including ribbons 320, buttons 322, brads 326, and flowers 330. It is to be appreciated that other embellishments may alternatively be used. In some embodiments, a label or a position for a label may be provided such that a label may be displayed on the band at the spine of the album, on the front of the album, or at other suitable location on the album. The label may further be used to provide gift information such as, “Baby Girl Album created by Mom”.

The band may be offered in designs such that, like the items in a kit, a consumer may match their album's band to their scrapbook theme. For pre-designed books having pre-applied embellishments, the embellishments may be affixed such that they do not fall off, break, or impede the stretching and releasing of the elastic material.

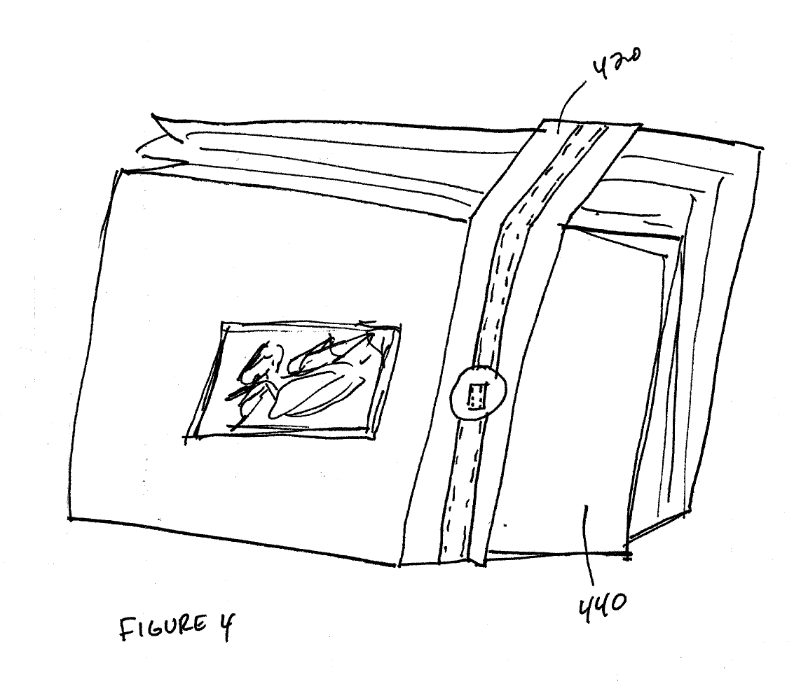

Suitable design or embellishment features for customizing the scrapbook band and/or for providing other options to a consumer for a scrapbook band include: varying widths, colors, prints and patterns, stitching, closures, fabric and ribbon weaves/braids, flowers and shapes, brads, beads, studs, gems, and tags and bows with message imprints (made of metal, plastic, cardstock, fabric, or any other suitable material or combination of materials) for special occasions—birthday, anniversary, graduation, baby, etc. It is to be appreciated that this list is for illustration only and is not intended to be limiting. FIGS. 4 illustrates and embodiment of a predecorated scrapbook band 420 secured around a scrapbook 440. While the band 420 is shown in a vertical orientation, the band may alternatively be suitable for placement in a horizontal orientation on a scrapbook album.

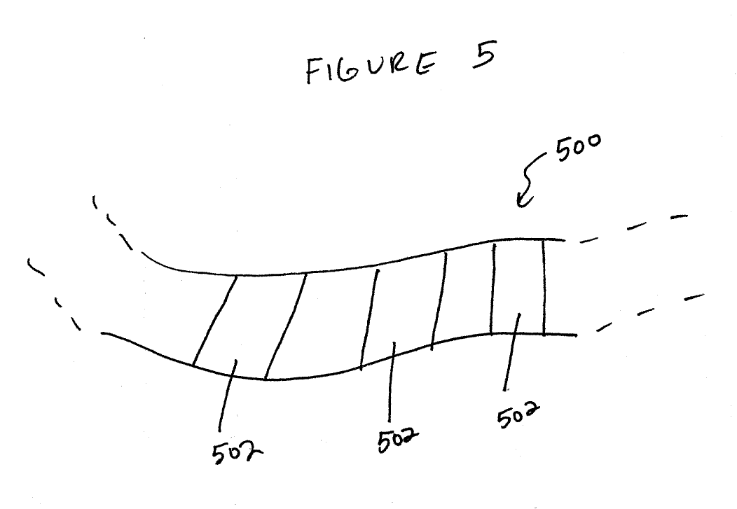

In some embodiments, the scrapbook band may be provided with landing areas for receipt of specific embodiments, selectable by a consumer, such that the consumer may customize the scrapbook band. FIG. 5 illustrates a customizable band 500 with example landing areas 502. As shown, cardstock or other material suitable for receiving an adhesive, for example, may be provided along the elastic material of the band 500. Sticker, gem, and other embellishments may be adhered to the landing area 502 by a consumer. The landing area 502 may be provided such that it is movable along the band or may be provided substantially fixed to the band, for example as by being stitched to the band.

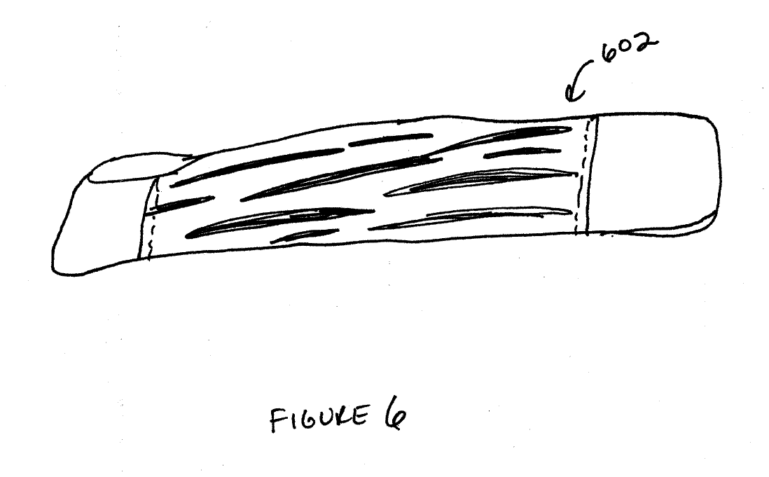

FIG. 6 illustrates a scrapbook band with landing areas formed as sleeves 602. The sleeve 602 in some embodiments may have embellishments included, while in other embodiments, the sleeve 602 itself may be decorative, e.g. comprised of a patterned fabric, while in still other embodiments, the sleeve 602 may be decorative and may include embellishments. In some embodiments a tag may be coupled to the landing area sleeve 602, for example, a tag might say “I DO!”

For embodiments of an open length design, any suitable closure mechanism may be used. Such mechanism may include button and loop, hook and eye, velcro, snap, button with traditional button hold, clasp, or other. In some embodiments, the closure mechanism may coordinate with the theme or design of the album. For example, a closure mechanism shaped as a diaper pin may be provided for use with a baby themed album, a closure mechanism shaped as a wedding ring may be provided for use with a wedding themed album, etc.

The scrapbook band may be sized to accommodate standard scrapbook sizes such as 12×12 albums, 8×8 albums, and 6×6 albums, or any other suitable or desired size. In addition, the band may be sized to fit journals, calendars, planner books, etc.

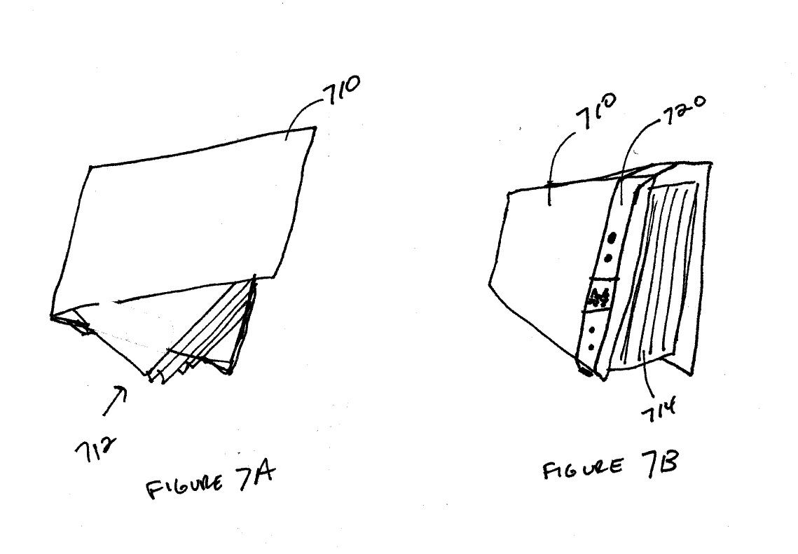

FIG. 7A illustrates an open, unbanded scrapbook album 710. As shown, the page protectors 712 are loose and prone to slippage. FIG. 7B illustrates the same scrapbook album 710 closed using a scrapbook band 720 in accordance with the present teachings. In some embodiments, the scrapbook band may stretch and release to “lock” the album and keep its contents in place, including pages and plastic sheet protectors which have a tendency to slide around and away from rings coupling them to the album; may stop sheet protectors from tearing at the ring holes due to repeated tugging motion from sliding; may quickly and easily grasp the cover of the album by stretching around it like a rubber band; may go on easily, and come off easily; may have only one major component plus its attached embellishments—easy for packaging, purchase, use and storage; may be used over and over again—remove to view the album, replace to store the album; and/or may be made of soft material that does not damage albums after repeated use. Some embodiments may be particularly useful for 3-ring or like albums, which are currently increasing in popularity compared to post-bound albums, but the 3-ring varieties are generally more prone to having pages slip out of their protectors.

Embodiments of the present disclosure may also advantageously provide a creative presentation for giving albums as gifts. For example, the band may “wrap” around the album and can include a personal message similar to an enclosure card, but it is a permanent accessory. The band may also provide an ability to label the scrapbook album.

In the foregoing description various embodiments of the invention have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What is claimed is:

1. A scrapbook band comprising:
an elastic material sized for wrapping around a scrapbook album,
at least one landing area being provided on the elastic material.

2. The scrapbook band of claim 1, wherein the scrapbook album comprises one or more protective sheets with individual pages placed therein.

3. The scrapbook band of claim 2, the scrapbook album comprising a 3-ring binder.

4. The scrapbook band of claim 2, the scrapbook album comprising a post-bound album.

5. The scrapbook band of claim 2, wherein the scrapbook band is a closed loop.

6. The scrapbook band of claim 5, wherein the landing area comprises a sleeve.

7. The scrapbook band of claim 6, wherein the sleeve is comprised of fabric.

8. The scrapbook band of claim 7, further comprising at least one embellishment.

9. The scrapbook band of claim 6, wherein the sleeve is comprised of cardstock.

10. The scrapbook band of claim 9, further comprising at least one embellishment.

11. The scrapbook band of claim 2, wherein the scrapbook band is an open length design.

12. The scrapbook band of claim 11, wherein the open length design comprises a plurality of closures.

13. The scrapbook band of claim 9, wherein the landing area comprises a sleeve.

14. The scrapbook band of claim 13, wherein the sleeve is comprised of fabric.

15. The scrapbook band of claim 14, further comprising at least one embellishment.

16. The scrapbook band of claim 13, wherein the sleeve is comprised of cardstock.

17. The scrapbook band of claim 16, further comprising at least one embellishment.

18. A scrapbook assembly comprising:
a 3-ring notebook with a plurality of 3-hole punched protective sheets;
one or more pages that may be disposed inside of the protective sheets; and
a securing strap that is removably securable to the exterior of the notebook, the securing strap having one or more landing areas.

19. The assembly of claim 18, the securing strap further comprising at least one embellishment.

20. A method of securing a scrapbook, the method comprising:
providing a scrapbook, the scrapbook having one more pages;
wrapping a scrapbook band around an exterior of the scrapbook, the scrapbook band being elastomeric and having at least one landing area.
